(19) United States
(12) Patent Application Publication
(10) Pub. No.: US 2014/0079474 A1
(43) Pub. Date: Mar. 20, 2014

(54) EMBEDDED FITTINGS

(71) Applicant: Apple Inc., Cupertino, CA (US)

(72) Inventors: David ANDREINI, San Francisco, CA (US); Karl Backus, Emeryville, CA (US); Robert Bridger, Woodside, CA (US); Tim Eliassen, Sunapee, NH (US); Scott David Hazard, Campbell, CA (US); James O'Callaghan, Winchester (GB); Jonathan P. Siegel, San Francisco, CA (US)

(73) Assignee: Apple Inc.

(21) Appl. No.: 13/871,709

(22) Filed: Apr. 26, 2013

Related U.S. Application Data
(63) Continuation of application No. 13/617,732, filed on Sep. 14, 2012, now abandoned.

(51) Int. Cl. F16B 5/00

(52) U.S. Cl. CPC F16B 5/0004
USPC 403/292; 29/525.01

(57) ABSTRACT

A joint for coupling glass elements having fittings embedded within the glass elements is provided. For example, such a joint may include a first fitting embedded in an edge face of a first glass panel, where the first fitting includes a first attachment feature, a second fitting embedded in an edge face of a second glass panel, where the second fitting is coupled to the first fitting and includes a second attachment feature, and a mechanical fastener coupling the first fitting to the second fitting by the first attachment feature and the second attachment feature.

### CROSS-REFERENCE TO RELATED APPLICATION

This application is a continuation of U.S. application Ser. No. 13/617,732, filed Sep. 14, 2012, the disclosure of which is incorporated herein in its entirety by reference thereto.

### BACKGROUND

1. Field

Embodiments of the present invention relate to embedded fittings and systems and methods relating thereto.

2. Background

A designer or other person may desire to join elements glass panels) together with fittings. In some cases, the designer or other person may desire to minimize interruption of the aesthetics of the elements due to fittings.

### BRIEF SUMMARY

To minimize interruption of aesthetics due to fittings used to couple two or more glass panels or other elements together, the fittings may be embedded within the glass panels or other elements. That is, such a fitting may extend partway within a glass panel or other element, without extending through the glass panel or other element. Such embedded fittings can help minimize interruption of one or more surfaces of the glass, thereby contributing to visual and structural integrity and continuity of such surfaces. Embodiments of such embedded fittings are described herein.

For example, some embodiments provide a joint including a first fitting embedded in an edge face of a first glass panel, wherein the first fitting includes a first attachment feature, a second fitting embedded in an edge face of a second glass panel, wherein the second fitting is coupled to the first fitting and includes a second attachment feature, and a mechanical fastener coupling the first fitting to the second fitting by the first attachment feature and the second attachment feature.

Also for example, some embodiments provide a joint including a fitting embedded in a plane surface of a glass panel, wherein the fitting includes a cylindrical head portion, and wherein the fitting defines an attachment feature disposed at a central axis thereof, and a mechanical fastener coupled to the attachment feature of the first fitting and to a fastened element, wherein the cavity does not extend through the glass panel.

Also for example, some embodiments provide an article of manufacture including a glass panel having a plurality of layers, wherein the glass panel defines a cavity between layers at an edge face of the glass panel, and a fitting embedded within the cavity having a fitting face aligned with the glass panel edge thee, wherein the fitting defines an elongated slotted inlay in the fitting face wherein the slotted inlay extends in the same direction as the layers at the edge face of the glass panel.

Also for example, some embodiments provide an article of manufacture including a glass panel defining a cavity extending from a plane face thereof, a fitting embedded within the cavity having an edge face aligned with the glass panel plane face, wherein the fitting defines an opening in the fitting face configured to receive a mechanical fastener, wherein the fitting does not extend through the glass panel.

Also for example, some embodiments provide a method of fixing glass elements together, the method including embedding a fitting within a cavity of a first glass element. Wherein the cavity does not extend through the first glass element, coupling a fastener to the fitting in an opening of the fitting, and coupling the fastener to a second element.

Additional features of embodiments of the invention will be set forth in the description that follows, and in part will be apparent from the description, or may be learned by practice of the invention. Both the foregoing general description and the following detailed description are exemplary and explanatory and are intended to provide further explanation of the invention as claimed.

### BRIEF DESCRIPTION OF THE FIGURES

The accompanying figures, which are incorporated herein, form part of the specification and illustrate embodiments described herein. Together with the description, the figures further serve to explain the principles of and to enable a person skilled in the relevant arts to make and use the invention.

FIG. 1 is a sectional front view of an edge-to-edge joint, according to an embodiment presented herein.

FIG. 2 is a partially-exploded perspective view of the edge-to-edge joint of FIG. 1, according to an embodiment presented herein.

FIG. 3 is a sectional top view of the edge-to-edge joint of FIG. 1, according to an embodiment presented herein.

FIG. 4 is a front view of a building including joints according to embodiments presented herein.

FIG. 5 is a sectional front view of a T-shape joint, according to an embodiment presented herein.

FIG. 6 is a partially-exploded perspective view of the T-shape joint of FIG. 4, according to an embodiment presented herein.

FIG. 7 is a sectional top view of the T-shape joint of FIG. 4, according to an embodiment presented herein.

FIG. 8 is a sectional side view of the T-shape joint of FIG. 4, according to an embodiment presented herein.

FIG. 9 is a sectional front view of an assembly operation of the T-shape joint of FIG. 4, according to an embodiment presented herein.

FIG. 10 is an enlarged sectional top view of a portion of the T-shape joint of FIG. 4, according to an embodiment presented herein.

FIG. 11 is a perspective view of the T-shape joint of FIG. 4.

FIG. 12 is a sectional perspective view of the T-shape joint of FIG. 4.

FIG. 13 is a sectional side view of an in-plane joint according to an embodiment presented herein.

FIG. 14 is a sectional top view of the in-plane joint of FIG. 13.

FIG. 15 is a sectional side view of an in-plane joint according to an embodiment presented herein.

FIG. 16 is a sectional side view of an in-plane joint according to an embodiment presented herein.

FIG. 17 is a perspective view of a staircase including joints according to embodiments presented herein.

FIG. 18 is a flow chart depicting a method of fixing elements together according to embodiments presented herein.

### DETAILED DESCRIPTION

Embodiments of the present invention will now be described in detail with reference to embodiments thereof as illustrated in the accompanying drawings, in which like reference numerals are used to indicate identical or functionally similar elements. References to “one embodiment”, “an embodiment”, “some embodiments”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

The following examples are illustrative, but not limiting, of the present invention. Other suitable modifications and adaptations of the variety of conditions and parameters normally encountered in the field, and which would be apparent to those skilled in the art, are within the spirit and scope of the invention.

Glass panels or other structural elements may be formed having a layered structure, where two or more layers of glass are fixed together on major surfaces thereof (e.g., by a laminating or other fusing technique) to form a continuous structure across layers thereof. Each of the layers may be formed with various sizes, shapes, and the like. For example, each of the layers may have the same thickness or a different thickness than the other layers. Furthermore, each of the layers may be formed with various materials. For example, each layer may be formed from the same or different material. In some embodiments, there is no space between adjacent layers, other than that which may be occupied by a bonding layer. Such a layered structure may impart strength (e.g., resistance to deformation, ability to bear loads) to the glass panel.

Any suitable glass material may be used for the glass layers (e.g., tempered glass, annealed glass, and the like), and any suitable bonding material may be used for the bonding layer (e.g., polyvinyl butyral (PVB) or other polymers such as Bucite and/or SentryGlas Plus, which are manufactured by Dupont of Wilmington, Del.). In some embodiments, the glass layers are laminated together via a SentryGlas Plus Ionoplast Interlayer (ionomeric extruded polymer) manufactured by Dupont of Wilmington, Del. (or equivalents thereof). The SentryGlas Plus Ionoplast Interlayer in between the glass layers may strengthen the laminate structure and hold it together. The SentryGlas Plus Ionoplast Interlayer also may allow thinner construction than is possible with conventional laminated glass. The SentryGlas Plus Ionoplast Interlayer may provide rigidity and stiffness to the laminate structure, (i.e., a loaded glass element tends to deflect less if formed using SentryGlas Plus Ionoplast Interlayer than if conventional interlayers were used). It is generally believed that SentryGlas Plus Ionoplast Interlayer offers about five times the tear strength, optimum durability and is nearly 100 times more rigid than conventional laminated glass interlayers. It is also believed that SentryGlas Plus Ionoplast Interlayers provide better flow during formation of the laminate structure.

Fittings may be used to couple two or more glass panels or other structural elements together, and may include attachment features to do so. U.S. Pat. No. 7,165,362, to Jobs et al., issued Jan. 23, 2007 and titled “Glass Support Member” describes layered glass panels and fittings, and is incorporated herein in its entirety by reference thereto.

According to embodiments described herein, such fittings may be embedded within the glass panels or other elements. That is, such a fitting may extend partway within a glass panel or other element, without extending through the glass panel or other element. Fittings embedded within the glass can help minimize interruption of one or more surfaces of the glass, thereby contributing to a visual and structural integrity and continuity of such surfaces. Fittings as described herein may be rigid and substantially incompressible under normal operating conditions, and may be formed of any suitable material or combination thereof, such as, for example, metal (e.g., titanium, aluminum, or stainless steel) or glass. In some embodiments, the material of the fittings is a metal having a similar coefficient of expansion to that of the glass panel. In this way, heating and cooling processes incident to manufacturing (e.g., a lamination process) do not result in damage (e.g., cracking) of the glass due to differing rates or extents of expansion. Titanium has a coefficient of expansion generally compatible with annealed glass in this way.

Such fittings embedded within glass elements may impart strength to the glass elements at points of connection with other elements, to increase the structural integrity of glass elements while minimizing interruption of visual characteristics of the glass elements, for example, by providing points of connection for mechanical fasteners.

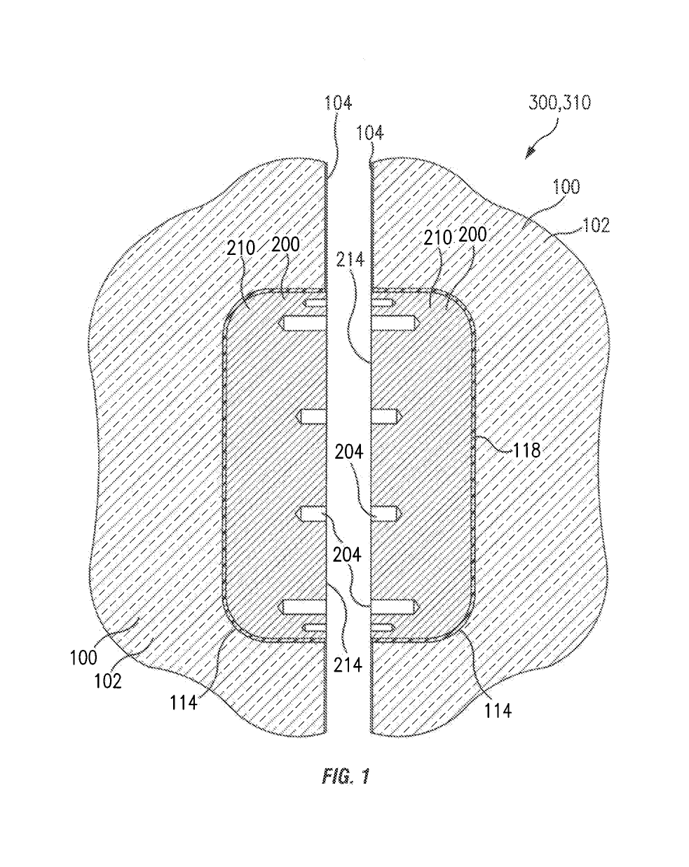

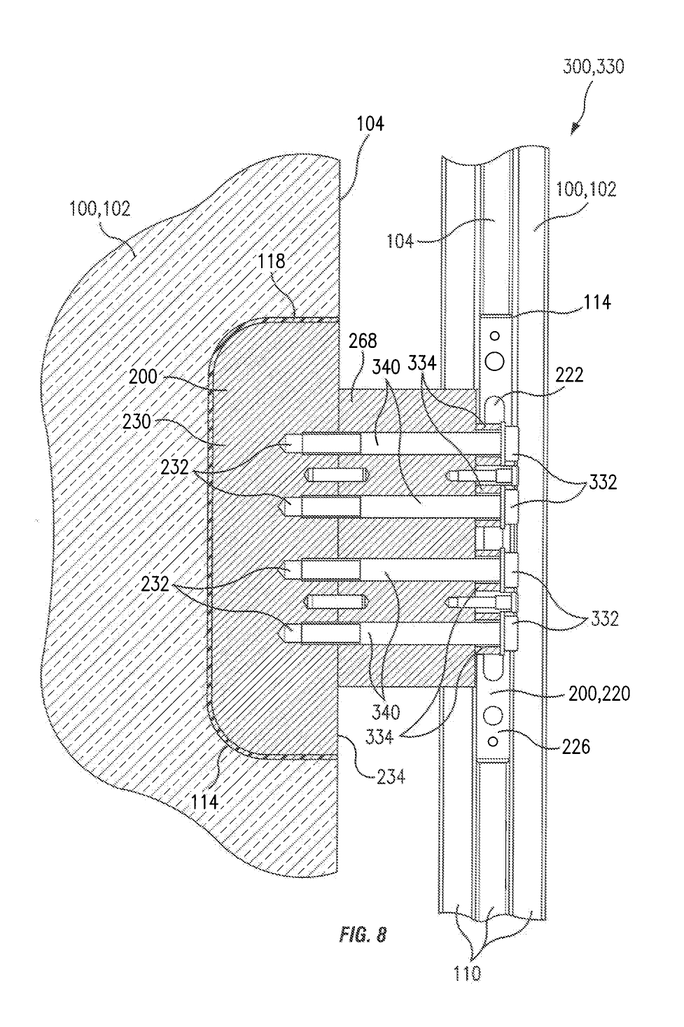

In some embodiments, as shown, for example, in FIGS. 1, 5, and 8, a fitting 200 can be embedded within a glass element 100. In some embodiments, fitting 200 can be fixed within glass element 100 by, for example, glue, epoxy, or mechanical fixing techniques. In some embodiments, fitting 200 is fixed within glass element 100 through a lamination process (e.g., during the same process by which layers 110 of glass panel 102 are laminated together). In such embodiments, fitting 200 may be bonded to glass panel 102 by the same material forming bonding layer 118 between adjacent glass layers 110, and such bonding layer 118 may extend around and between fittings 200 and glass layers 110. In embodiments using an ionoplast interlayer (e.g., SentryGlas Plus Ionoplast Interlayer) as bonding layer 118, such bonding of fittings within glass element 100 causes fitting 200 to act as a structural extension of glass element 100, thus contributing no weakness to glass panel 100. In this way, fitting 200 acts as a uniform monolithic structure with glass element 100.

In some embodiments, fitting 200 may be applied with activators or other adhesion promoters to promote bonding between fitting 200 and bonding layer 118 (e.g., by providing a uniform bonding surface). For example, fitting 200 may be applied with epoxy, structural silicone, or another structural paste such as, for example, those marketed by Hilti Corporation of Schaan, Liechtenstein.

For example, fitting 200 can be laminated within a laminated glass panel 102 at an edge face 104 thereof. Some embodiments are described herein with respect to glass panels 102 (e.g., glass building walls, stair stringers, stairs) for ease of explanation, however, such embodiments can be applied to any glass element 100 or even non-glass elements, and are not limited to glass panels 102.

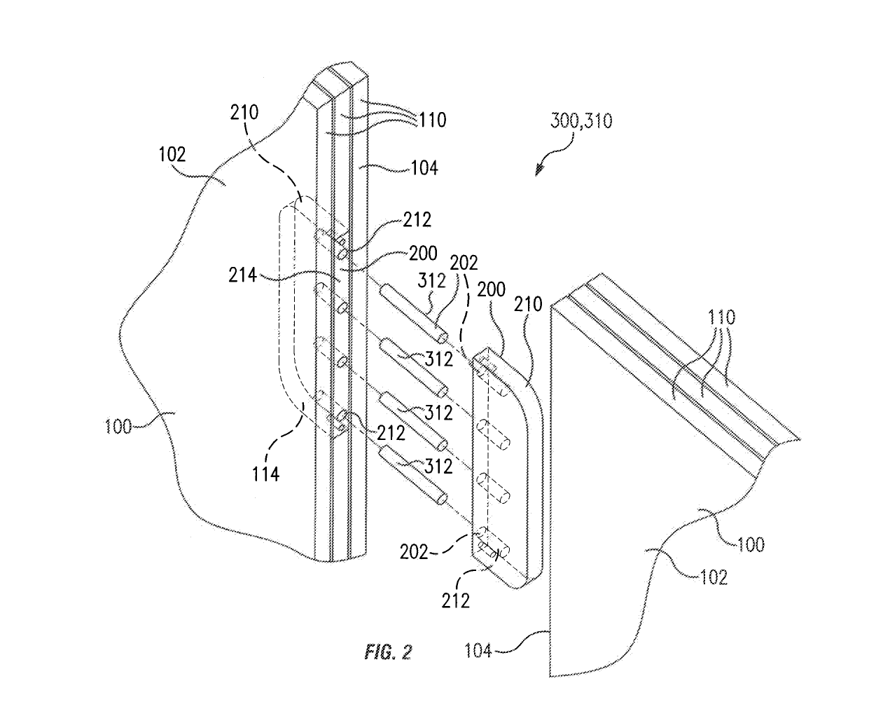

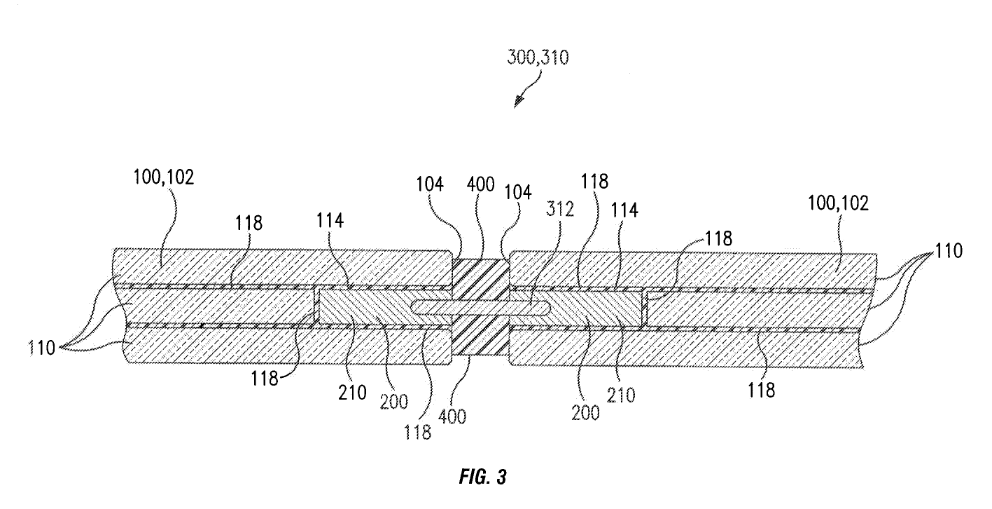

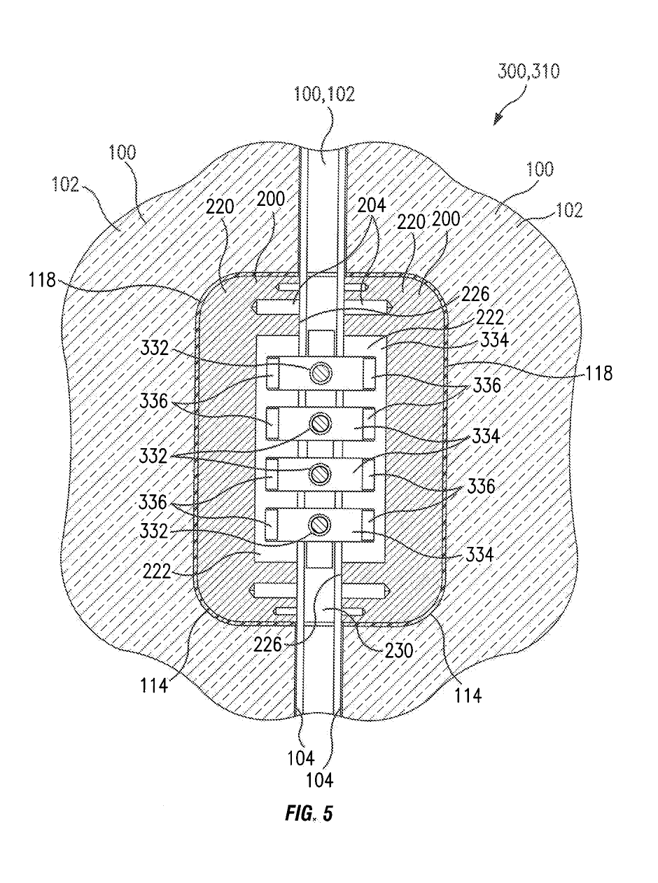

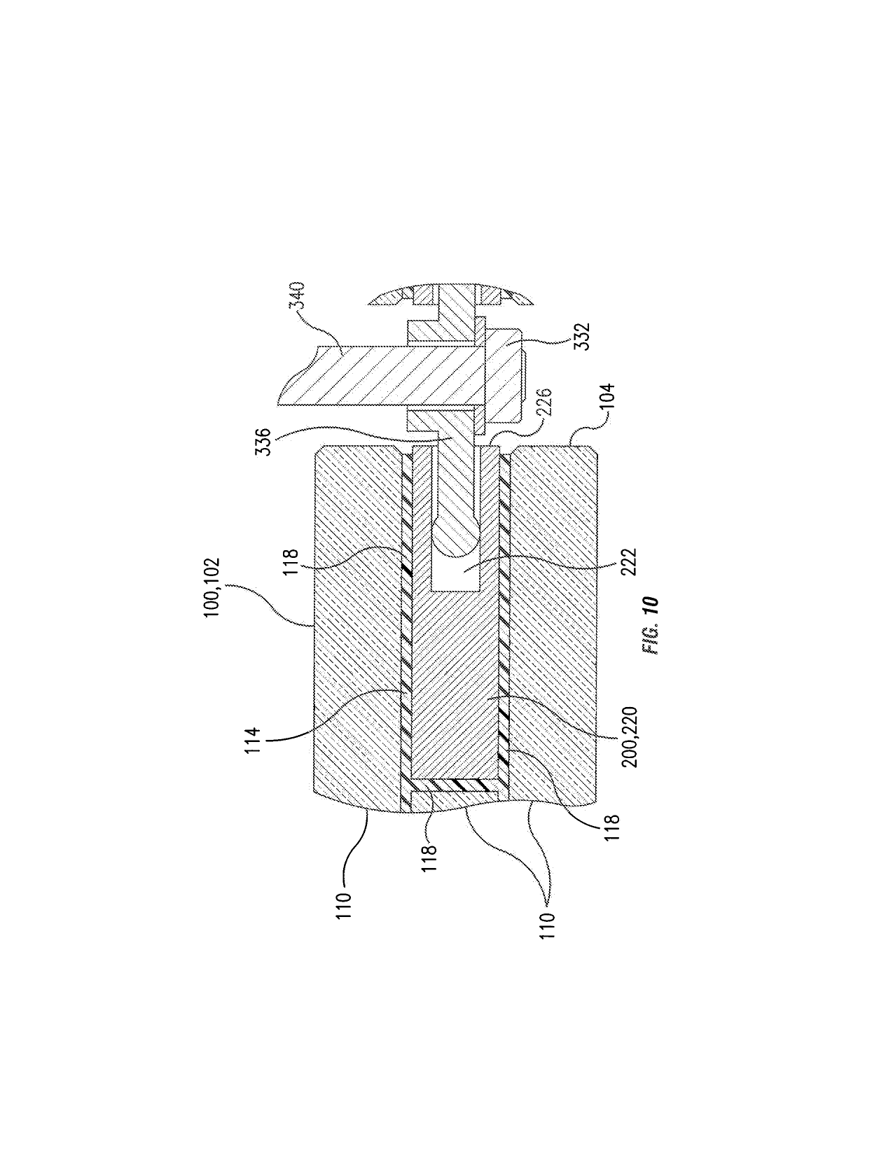

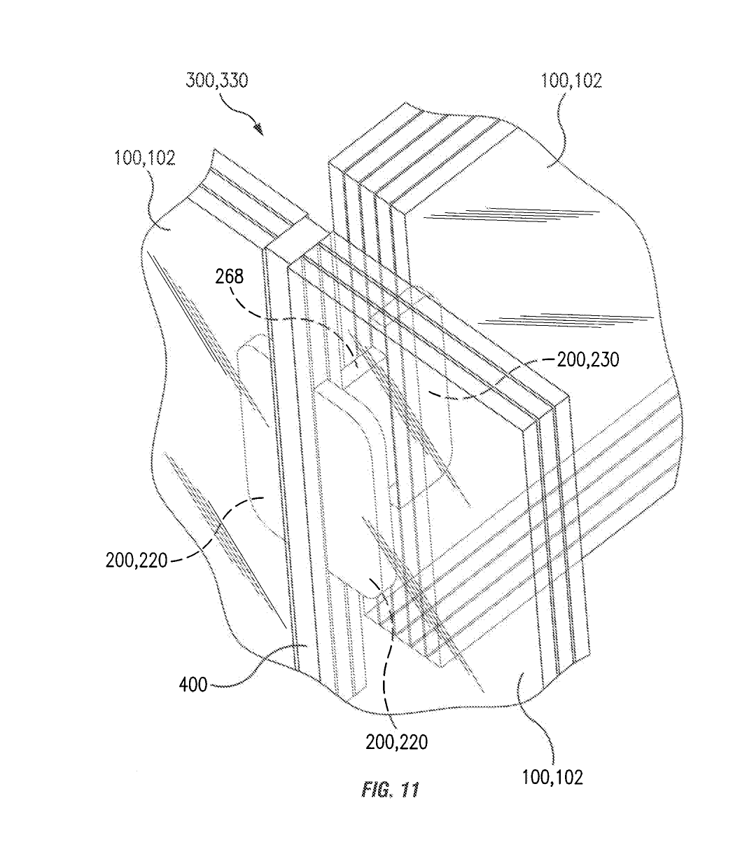

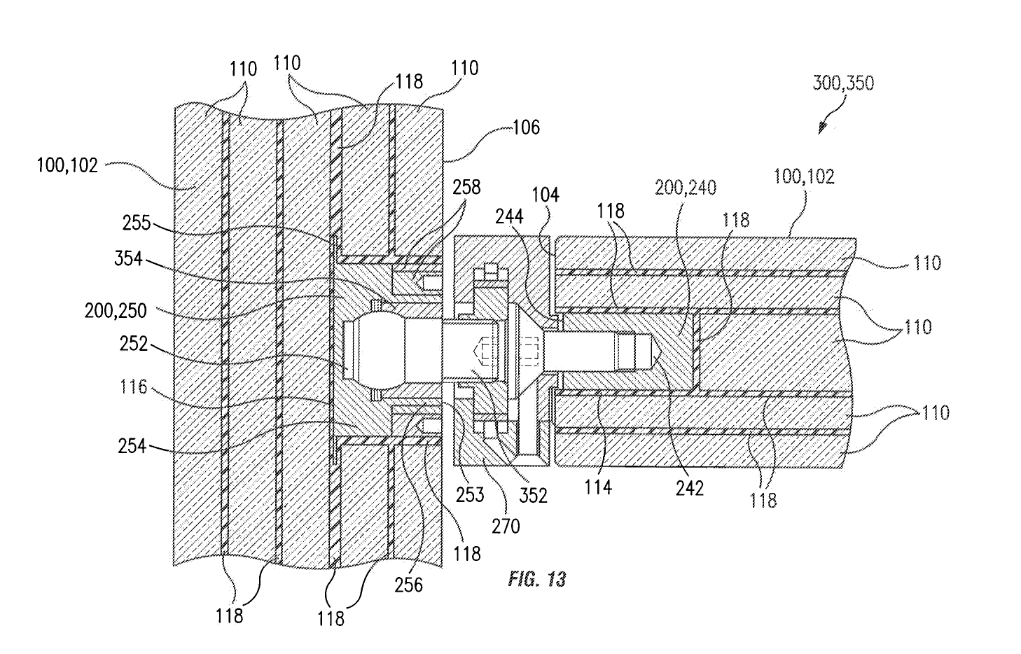

In some embodiments, a portion of glass element 100 may be omitted to form a cavity (e.g., edge cavity 114 formed in edge face 104 of glass element 100 or plane cavity 116 formed in a plane face 106 of glass element 100, as shown in FIGS. 3, 7, and 13) in glass element 100 to accommodate fitting 200 therein. For example, a portion of at least one layer 110 of glass panel 102 may be omitted (as compared to one or more other layers 110) to form cavity 114 or 116. In some embodiments, such cavities may not extend through glass panel 102. In some embodiments, such cavities may extend over a relatively smaller length than the length of the edge face in which such cavities are formed. Fitting 200 disposed within a cavity and aligned with another fitting may be aligned and coupled together via fasteners (e.g., fasteners 312) to fix two or more glass elements 100 together, or to fix glass element 100 to any other element, thereby forming a joint 300. Several joint types can be formed using fittings 200 as described herein, such as, for example, an “edge-to-edge” joint 310 (see FIGS. 1-3), a T-shape joint 330 (see FIGS. 5-12), or an in-plane joint 350 (see FIGS. 13-16).

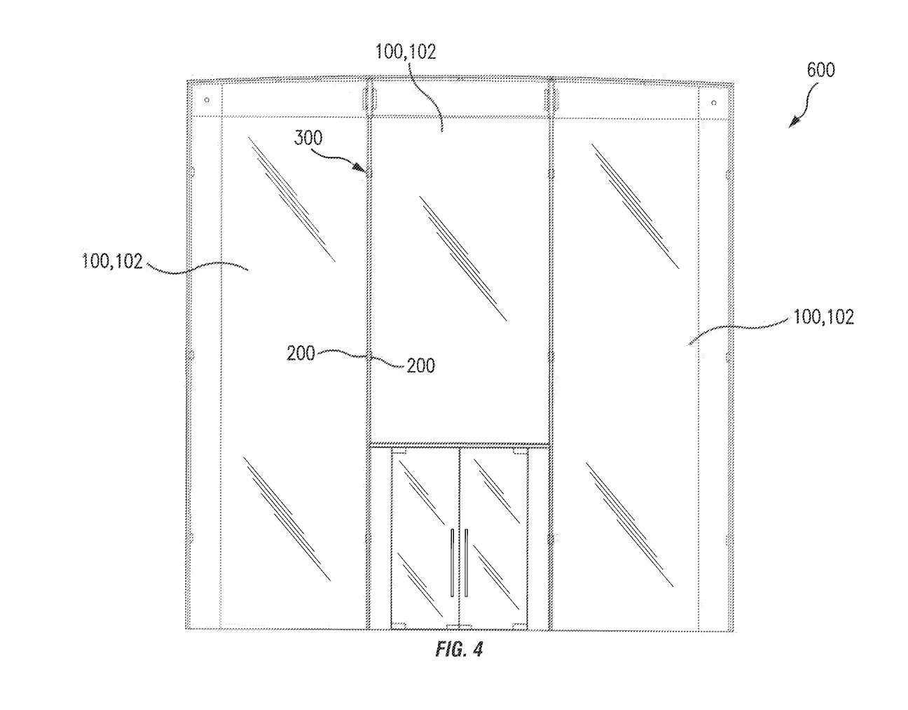

FIG. 4 illustrates an exemplary building, shown generally at 600, having glass panels 102 coupled together by fittings 200. Fittings 200 shown in FIG. 4 are embedded within edge faces 104 of adjacent panels 102. Corresponding fittings 200 (i.e., fittings adjacently aligned in the assembled building 600) may be themselves coupled together by mechanical fasteners (e.g., fasteners 312 described below). In some embodiments, such mechanical fasteners may extend within fittings 200, but not through fittings 200. Having such fasteners coupled within embedded fittings 200 rather than directly to glass panels 102 reduces strain on the coupled areas of glass panels 102 and improves their structural integrity. In some embodiments, to assemble adjacent panels 102 as shown in exemplary building 600, each adjacent panel 102 may be formed having corresponding edge cavities 104. A fitting 200 may be inserted and fixed within each edge cavity 104. Panels 102 may be aligned such that attachment features (e.g., openings 212) in fittings 200 align. A mechanical fastener (e.g., fastener 312) may then be inserted and secured within the corresponding openings, thereby securing glass panels 102 together.

In some embodiments, joint 300 may be formed between two glass panels 102, as shown in FIGS. 1-3, for example, by the alignment of attachment features 202 of fittings 200. For example, a pair of fittings 200 (e.g., “type A fittings 210”) embedded within edge cavities 114 of a pair of glass panels 102 may have corresponding threaded or unthreaded openings 212 that can receive dowels, bolts, screws, or other fasteners 312 to align and maintain the relative position of a pair of glass panels 102. In some figures, fasteners may be omitted for clarity. In some embodiments, a face 214 of type A fitting 210 may align with or be recessed from edge face 104 of glass panel 102. In some embodiments, type A fitting 210 does not extend beyond edge face 104 of glass panel 102. A joint 300 joining two glass panels 102 edge-to-edge this way may be referred to as an edge-to-edge joint 310. In some embodiments, a third fitting 200 embedded within an edge cavity 114 of a third glass panel 102 (e.g., laminated therein as described above) can interact with an otherwise edge-to-edge joint 310 to join three glass panels 102 (e.g., as in a T-shape joint 330). In some embodiments, edge cavities 114 (and fittings 200 embedded therein) may not extend through glass panels 102.

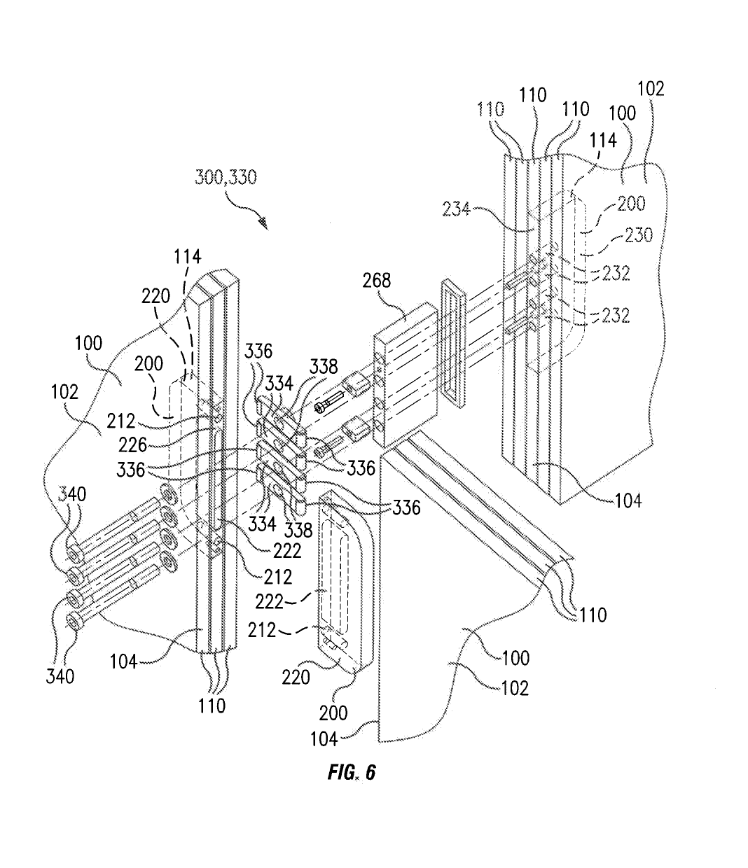

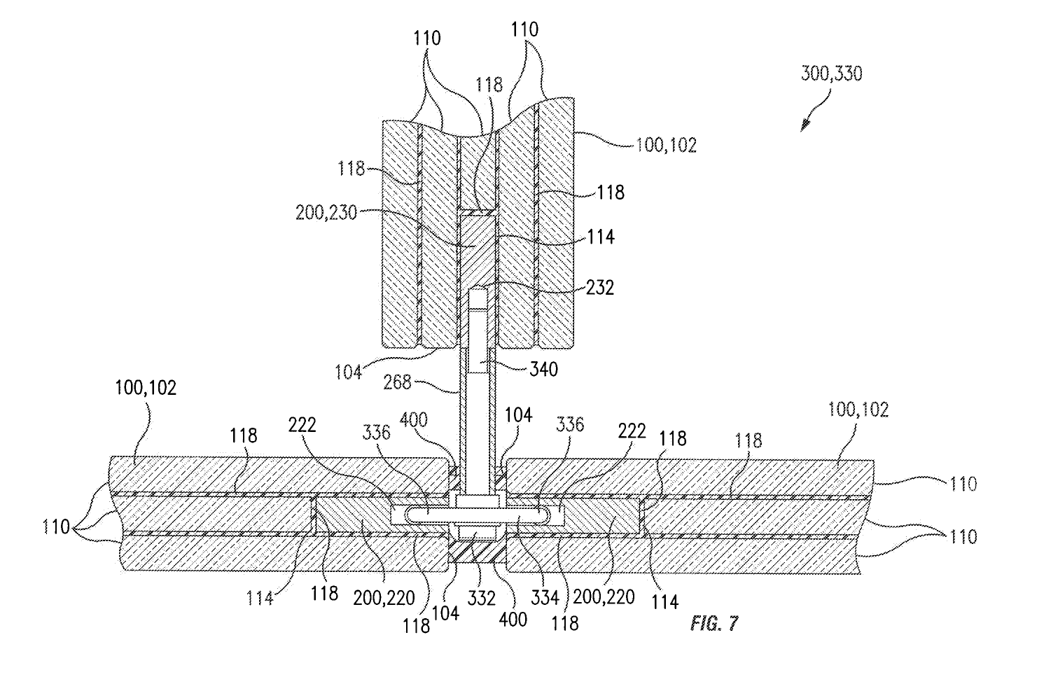

In some embodiments, T-shape joint 330 may be formed among three glass panels 102, as shown in FIGS. 5-12, each having a fitting 200 embedded therein. In some embodiments of such T-shape joint 330, two fittings 200 each embedded in a glass panel 102 couple the two glass panels 102 together as described, for example, for an edge-to-edge joint 310, while a third fitting 200 embedded in a third glass panel 102 is coupled at an interface between the first two fittings 200, thereby forming a T-shape. In some embodiments, the two fittings 200 coupling the two glass panels 102 together as described for an edge-to-edge joint 310 are fittings of a first type (“type B fittings 220”), while the third fitting 200 coupling a third glass panel 102 at an interface between the two type B fittings 220 is a fitting of a second type (“type C fitting 230”), as shown, for example, in FIGS. 6 and 7. In some embodiments, a face 226 of type B fitting 220 and a face 234 of type C fitting 230 may align with or be recessed from edge faces 104 of their respective glass panels 102. In some embodiments, type B fitting 220 and type C fitting 230 do not extend beyond edge faces 104 of their respective glass panels 102. In some embodiments, type B fittings 220 and type C fitting 230 can couple together glass panels 102 in a glass structure, such as, for example, exemplary building (shown generally at 600 in FIG. 4).

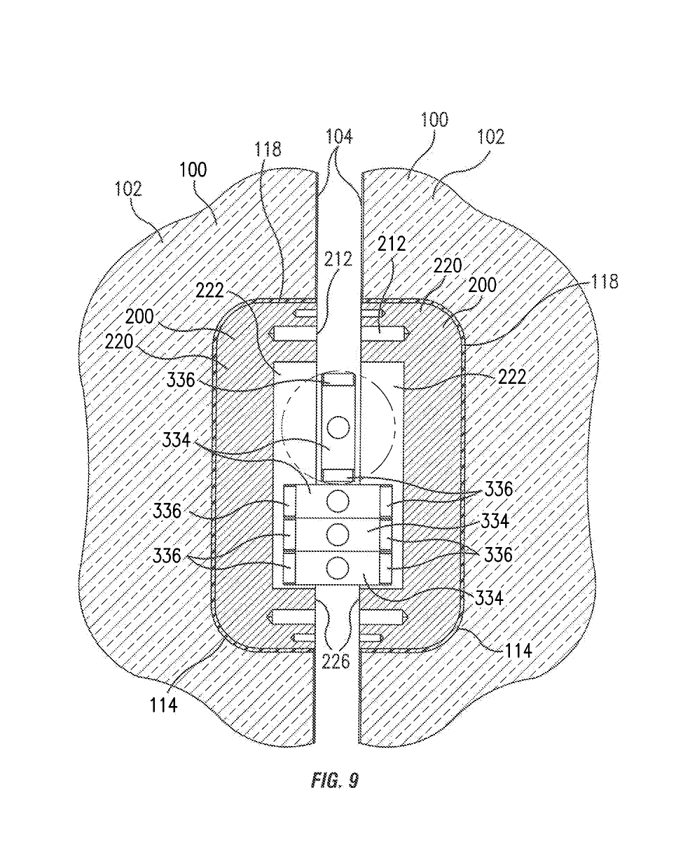

In some embodiments, type B fittings 220 forming T-shape joint 330 include a slotted inlay 222 to receive attachment wings 334 of a joint connector 332 (see, e.g., FIGS. 5 and 7). In some embodiments, slotted inlay 222 may be defined in face 226 of type B fitting 220, and may be elongated extending in the same direction as layers 110 at edge face 104. In a T-shape joint 330 configuration, slotted inlays 222 of adjacent type B fittings 220 align with each other, as shown, for example, in FIG. 5. Attachment wings 334 of joint connector 332 can be inserted and secured within slotted inlays 222 (see, e.g., FIG. 9). Attachment wing 334 can include arms 336 that can each extend and be secured within one of a pair of aligned slotted inlays 222, as shown, for example, in FIG. 5. Attachment wings 334 or portions thereof may be secured within the slotted inlays 222 by, for example, welding, glue, epoxy, or mechanical fasteners.

In some embodiments, each attachment wing 334 includes an opening 338 therethrough positioned between its arms 336, through which a fastener 340 may extend toward a third glass panel 102. Fastener 340 may be any suitable fastener, including, for example, a bolt, screw, or dowel. In some embodiments, such fastener 340 may extend into and be secured within a corresponding opening 232 in an aligned type C fitting 230 to secure the type C fitting 230 (and glass panel 102 within which it is laminated) relative to the two type B fittings 220 (and their glass panels 102), thereby forming T-shape joint 330.

Any suitable number X of joint connectors 332 can be used to couple type C fitting 230 to type B fittings 220 in T-shape joint 330. In some embodiments, slotted inlays 222 of an aligned pair of slotted inlays 222 are sized to together accommodate all X attachment wings 334 (of the X joint connectors) in transverse configurations as shown, for example, in FIG. 5 (i.e., with arms 336 of each attachment wing 334 disposed within each slotted inlay 222). In some embodiments, slotted inlays 222 of an aligned pair of slotted inlays 222 are sized to together accommodate X-1 attachment wings 334 (of the X joint connectors) in transverse configurations and 1 attachment wing 334 in a longitudinal configuration, as shown in FIG. 9. In this way, attachment wings 334 of joint connectors 332 can be inserted within aligned slotted inlays 222 even when the positions of such aligned slotted inlays 222 are fixed relative to each other. In other words, attachment wing 334 can be positioned longitudinally between aligned slotted inlays 222 (as is the top attachment wing 334 in FIG. 9) and can then be rotated to a transverse orientation. Such rotation may cause attachment arms 336 of attachment wing 334 to enter slotted inlays 222, and attachment wing 334 can be moved within slotted inlay 222 as needed to accommodate entry of additional attachment wings 334. Once all attachment wings 334 are within a pair of slotted inlays 222, attachment wings 334 can be positioned as desired (e.g., to correspond to openings in type C fitting 230) to form T-shape joint 330 as described above.

In some embodiments, a fitting 200 of joint 300 may be spaced apart from one or more other fittings 200 of joint 300 by a spacer 268. In such an embodiment, fasteners (e.g., fasteners 340 or 312) may extend through spacer 268 to thereby couple the corresponding fitting 200, as shown, for example, in FIGS. 6-8. In some embodiments, spacer 268 has a shape corresponding to the shape of a spaced fitting 200. Spacer 268 may be a single monolithic element, or may be formed of multiple elements joined together.

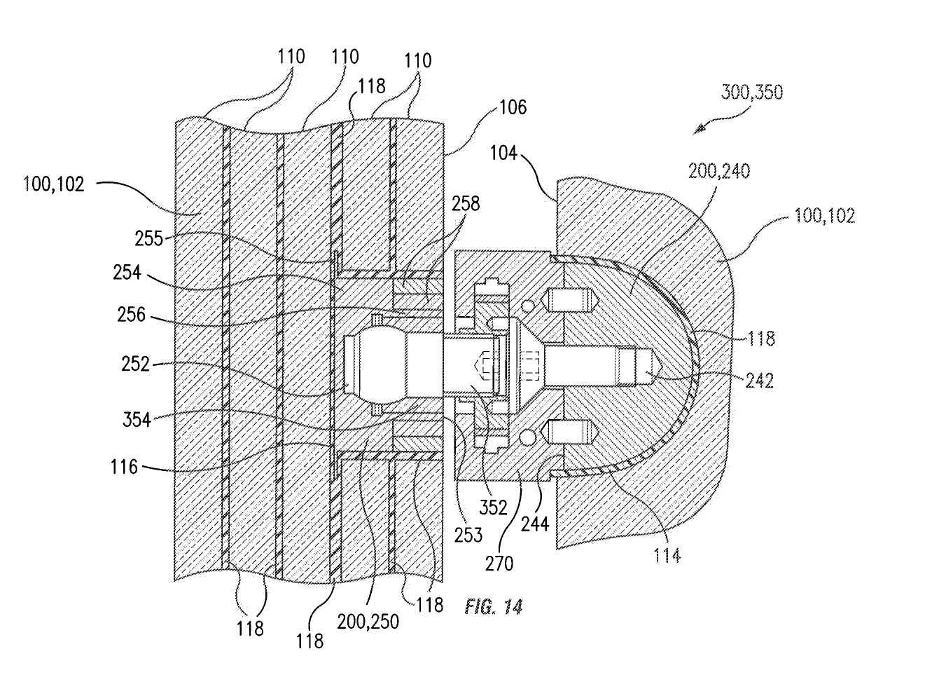

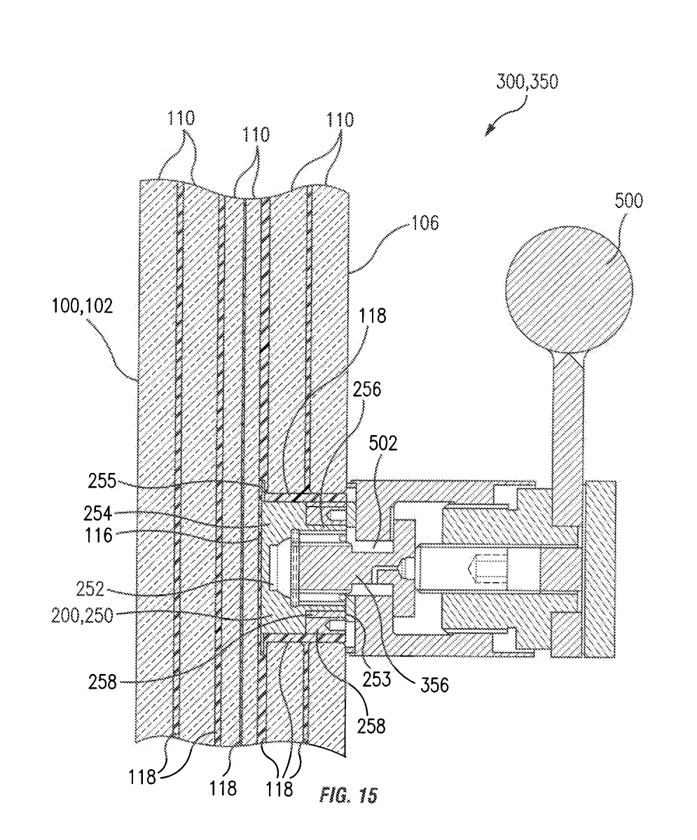

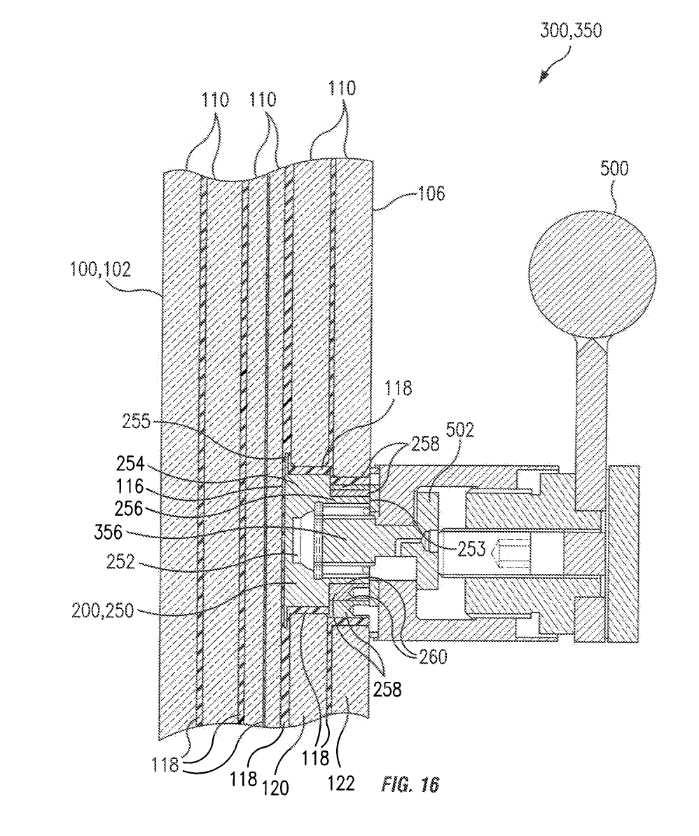

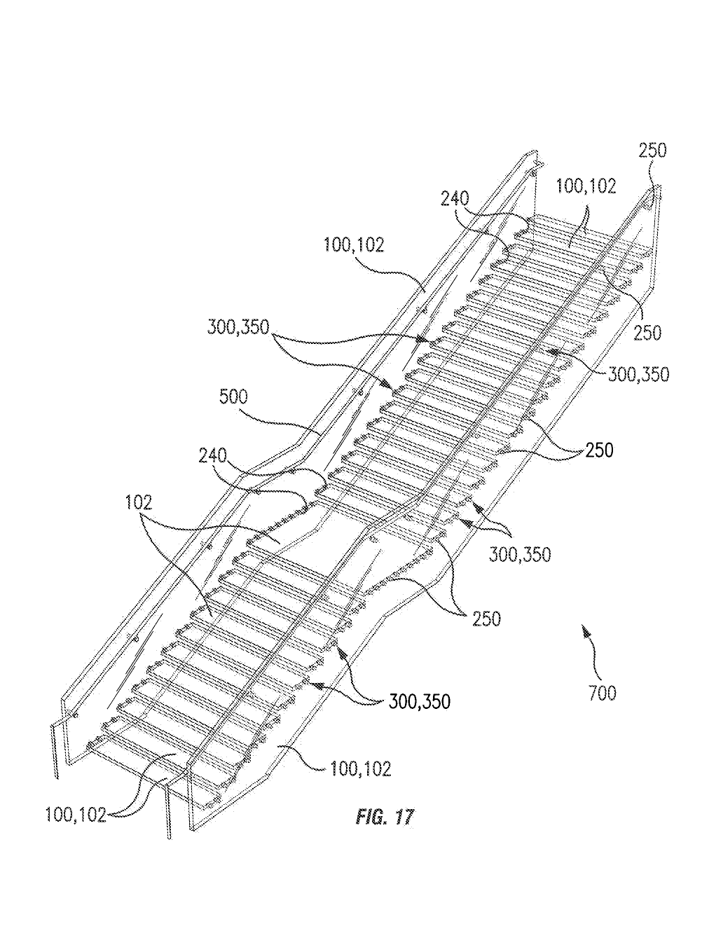

In some embodiments, in-plane joint 350 may be formed in a plane face 106 of glass panel 102 (e.g., extending between two glass panels 102, as shown in FIGS. 13 and 14, or between a glass panel 102 and a non-glass panel element 500, as shown in FIGS. 15 and 16). In some embodiments, such in-plane joint 350 includes two fittings 200: a “type D fitting 240” and a “type E fitting 250” as shown in FIGS. 13 and 14. Type D fitting 240 may be disposed and fixed within a first glass panel 102 in edge face 104 thereof, and thereby embedded within the first glass panel 102. For example, type D fitting 240 may be laminated within a laminated first glass panel 102 as described above. In some embodiments, a face 244 of type D fitting 240 may align with or be recessed from edge face 104 of the first glass panel 102. In some embodiments, type D fitting 240 does not extend beyond edge face 104 of the first glass panel 102. In some embodiments, type D fitting has a semi-circular disc shape, and is fixed within a glass stair (see FIGS. 14 and 17), such as, for example, in the glass staircase disclosed in U.S. Design Patent Application No. 29/432,305, fled Sep. 14, 2012, which is incorporated herein in its entirety by reference thereto. In some embodiments, type D fitting 240 may include an opening 242 (e.g., threaded or unthreaded) that can receive a dowel, bolt, screw, or other fastener 352.

Type E fitting 250 of some embodiments of in-plane joint 350 may be disposed and fixed within a second glass panel 102 in plane face 106 thereof, and thereby embedded within the second glass panel 102. In other words, type E fitting 250 need not be disposed at an edge of the second glass panel 102. In some embodiments, type E fitting 250 may be laminated within a laminated second glass panel 102. For example, type E fitting may include a flange 255 laminated between adjacent layers 110 of second glass panel 102 (e.g., within bonding layer 118). Second glass panel 102 may be, for example, a glass stringer for a staircase (especially where the first glass panel 102 is a stair), for example, as shown generally at 700 in FIG. 17. Second glass panel 102 may define a plane cavity 116 extending at least partway within second glass panel 102 from a plane surface thereof. For example, in a multi-layered glass panel 102 (see, e.g., FIG. 13), plane cavity 116 may extend through one or more layers 110. In some embodiments, plane cavity 116 does not extend completely through glass panel 102. In some embodiments, a face 253 of type E fitting 250 may align with or be recessed from plane face 106 of the second glass panel 102. In some embodiments, type E fitting 250 does not extend beyond plane face 106 of the second glass panel 102.

Plane cavity 116 may be shaped to receive type E fitting 250. For example, in some embodiments, type E fitting 250 may be disc-shaped, and plane cavity 116 may also be disc-shaped and sized to receive type E fitting 250. Type E fitting 250 may be fixed within plane cavity 116 of second glass panel 102 by, for example, glue, epoxy, or mechanical fixing techniques. In some embodiments, Type E fitting 250 is fixed within glass element 100 through a lamination process as described above. In some embodiments, type E fitting 250 may include an opening 252 (e.g., threaded or unthreaded) that can receive a dowel, bolt, screw, or other fastener 352. In some embodiments, opening 252 does not extend entirely through type E fitting 250.

In-plane joint 350 may include a fastener 340 extending between type D fitting 240 and type E fitting 250, to thereby couple type D fitting 240 (and first glass panel 102) to type E fitting 250 (and second glass panel 102). In some embodiments, fastener 340 couples type D fitting 240 and type E fitting 250 by extending into openings 242, 252 and being secured therein. Fastener 340 may be any suitable fastener, including, for example, a bolt, screw, or dowel. For example, FIGS. 13 and 14 show fastener 352 having a threaded end coupled to type D fitting 240, and a spherical screw end coupled to type E fitting 250 and extending along a central axis of cylindrical head portion 254 thereof (with a corresponding O-ring 354 retaining the spherical screw end of fastener 352 within type E fitting 250).

In some embodiments, a fitting 200 of joint 300 may be spaced apart from one or more other fittings 200 of joint 300 by a spacer 270. In such an embodiment, fasteners (e.g., fastener 340) may extend through spacer 270 to thereby couple the corresponding fitting 200, as shown, for example, in FIGS. 13 and 14. In some embodiments, spacer 270 has a shape corresponding to the shape of type E fitting 250 (e.g., disc-shaped) and fastener 340 extends through a center thereof. Spacer 270 may be a single monolithic element, or may be formed of multiple elements joined together.

In some embodiments, fittings 200 as described herein can be used to form joints 300 coupling non-glass elements together. For example, in some embodiments of in-plane joint 350, a non-glass-panel element 500 is coupled to a glass panel 102 via a type E fitting 250 (see, e.g., FIG. 15). In such an embodiment, a fastener 356 may couple non-glass-panel element 500 to glass panel 102 by extending into opening 252 of type F fitting 250 and being secured therein, while also being coupled to the non-glass-panel element 500 (e.g., by extending into an opening 502 and being secured therein). In some embodiments, non-glass-panel element 500 may be a handrail mounting assembly, as shown in FIG. 15.

In some embodiments, fittings 200 extend through more than one layer 110 of a layered glass panel 102. In some embodiments, openings in these layers 110 defining cavities for receiving fittings 200 (e.g., plane cavity 116) may be misaligned. In other words, the openings may not be coaxial. For example, in the plane cavity 116 shown in FIG. 16, an opening in layer 120 is aligned higher than an opening in layer 122. In some embodiments, type B fitting 250 can be adjusted to fit securely within the misaligned plane cavity 116. For example, type E fitting 250 can have a head portion 254 and a neck portion 256. Both of head portion 254 and neck portion 256 may be cylindrical, with neck portion 256 having a diameter less than a diameter of head portion 254. In some embodiments, neck portion 256 can be fitted with one or more adjustment collars 258, each having an opening 260 for receiving neck portion 256 or another adjustment collar 258. In some embodiments, openings 260 are off-center such that they can be aligned coaxially with type E fitting 250, while the balance of adjustment collars 258 can be aligned to fit within the misaligned opening in layer 122. In this way, type F fitting 250 can be adjusted to be fit within a misaligned plane cavity 116.

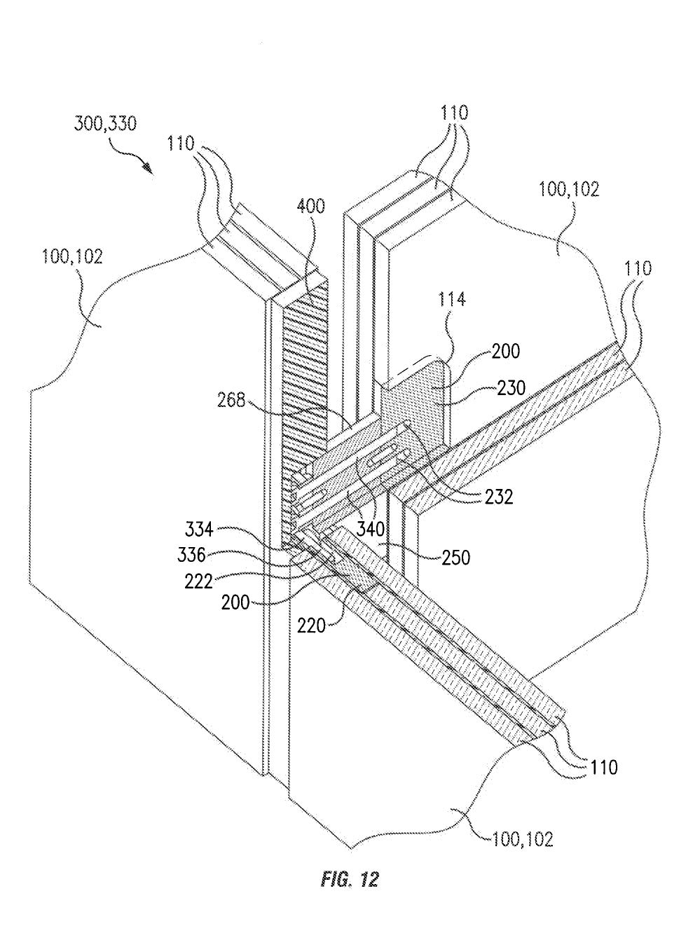

In some embodiments, joints 300 may include a filler 400 to fill any gaps between fitting elements (e.g., fittings 200) or fitted elements (e.g., glass elements 100) (see, e.g., FIG. 12). In some embodiments, filler 400 is silicone. In some embodiments, the silicone of filler 400 is transparent.

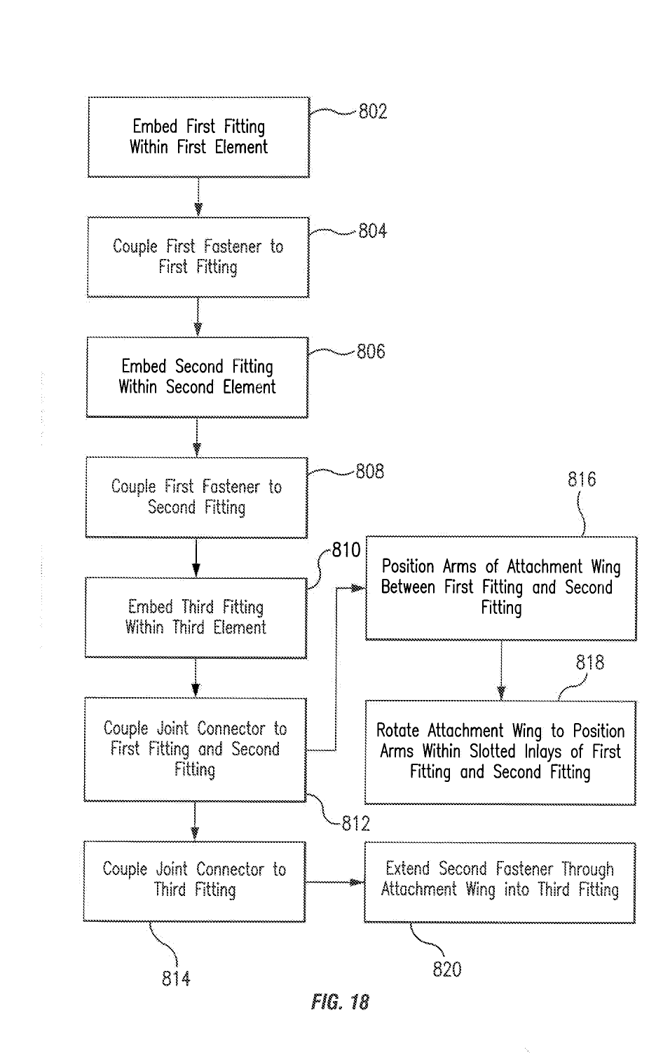

FIG. 18 shows steps of a method of fixing elements together using the techniques described herein. For example, in some embodiments, a first fitting (e.g., a first type B fitting 220) may be embedded within a first element (e.g., a first glass panel 102) (see operation 802), and a first fastener (e.g., fastener 312) may be coupled to the first fitting (see operation 804) and to a second fitting (see operation 808) (e.g., a second type B fitting 220). The second fitting may be embedded within a second element (e.g., a second glass panel 102) (see operation 806). In some embodiments, a third fitting (e.g., a type C fitting 230) may be embedded within a third element (e.g., a third glass panel 102) (see operation 810). In some embodiments, a joint connector (e.g., joint connector 332) may be coupled to the first fitting and the second fitting at one end thereof (see operation 812), and may be coupled to the third fitting at another end thereof (see operation 814). In some embodiments, coupling the joint connector to the first fitting and the second fitting may include positioning arms of an attachment wing (e.g., arms 336 of attachment wing 334) between aligned slotted inlays (e.g., slotted inlays 222) of the first fitting and the second fitting (see operation 816), and rotating the attachment wing to position the arms of the attachment wing to extend within each of the aligned slotted inlays simultaneously (see operation 818). In some embodiments, coupling the joint connector to the third fitting includes extending a second fastener (e.g., fastener 340) through the attachment wing between the first fitting and the second fitting and into the third fitting (see operation 820).

The foregoing description of the specific embodiments of the joints and embedded fittings described with reference to the figures will so fully reveal the general nature of the invention that others can, by applying knowledge within the skill of the art, readily modify and/or adapt for various applications such specific embodiments, without undue experimentation, without departing from the general concept of the present invention.

While various embodiments of the present invention have been described above, they have been presented by way of example only, and not limitation. It should be apparent that adaptations and modifications are intended to be within the meaning and range of equivalents of the disclosed embodiments, based on the teaching and guidance presented herein. It therefore will be apparent to one skilled in the art that various changes in form and detail can be made to the embodiments disclosed herein without departing from the spirit and scope of the present invention. The elements of the embodiments presented above are not necessarily mutually exclusive, but may be interchanged to meet various needs as would be appreciated by one of skill in the art.

It is to be understood that the phraseology or terminology used herein is for the purpose of description and not of limitation. The breadth and scope of the present invention should not be limited by any of the above-described exemplary embodiments, but should be defined only in accordance with the following claims and their equivalents.

What is claimed is:

1. A joint, comprising:
a first fitting embedded in an edge face of a first glass panel, wherein the first fitting comprises a first attachment feature;
a second fitting embedded in an edge face of a second glass panel, wherein the second fitting is coupled to the first fitting and comprises a second attachment feature; and
a mechanical fastener coupling the first fitting to the second fitting by the first attachment feature and the second attachment feature.

2. The joint of claim 1, wherein the first attachment feature comprises a first opening defined by the first fitting,
wherein the second attachment feature comprises a second opening defined by the second fitting, and
wherein the first opening and the second opening are each configured to simultaneously receive a portion of the mechanical fastener.

3. The joint of claim 1, further comprising a third fitting embedded in an edge face of a third glass panel, wherein the third fitting is coupled to the first fitting and the second fitting at an interface between the first fitting and the second fitting.

4. The joint of claim 3, wherein the first fitting defines a first slotted inlay therein,
wherein the second fitting defines a second slotted inlay therein, and
wherein the first slotted inlay and the second slotted inlay are aligned.

5. The joint of claim 4, comprising a joint connector, wherein the joint connector comprises:
an attachment wing defining an opening therethrough, wherein the attachment wing extends between the first slotted inlay and the second slotted inlay, and wherein the attachment wing comprises a first arm disposed within the first slotted inlay and a second arm disposed within the second slotted inlay; and
a second mechanical fastener coupling the first fitting and the second fitting to a third attachment feature of the third fitting through the opening of the attachment wing.

6. The joint of claim 3, wherein the third fitting extends perpendicular to the first fitting and the second fitting.

7. A joint, comprising:
a fitting embedded in a plane surface of a glass panel, wherein the fitting comprises a cylindrical head portion, and wherein the fitting defines an attachment feature disposed at a central axis thereof; and
a mechanical fastener coupled to the attachment feature of the first fitting and to a fastened element,
wherein the cavity does not extend through the glass panel.

8. The joint of claim 7, wherein the fastened element is a second fitting disposed within a cavity in an edge face of a second glass panel.

9. The joint of claim 8, wherein the cavity in the edge face of the second glass panel does not extend through the second glass panel.

10. The joint of claim 7, wherein the fitting is formed of glass.

11. The joint of claim 7, wherein the glass panel comprises a first layer and a second layer,
wherein the cavity is defined by an opening in each of the first layer and the second layer, and
wherein the opening in the first layer is not aligned with the opening in the second layer.

12. The joint of claim 11, wherein the cylindrical head portion of the fitting is disposed within the opening in the second layer,
wherein the fitting comprises a cylindrical neck portion disposed within the opening in the first layer, and
wherein a diameter of the cylindrical neck portion is less than a diameter of the cylindrical head portion.

13. The joint of claim 12, comprising an adjustment collar within the opening in the first layer, the adjustment collar comprising an off-center opening,
wherein the opening of the adjustment collar is disposed about the cylindrical neck portion of the fitting.

14. An article of manufacture, comprising:
a glass panel having a plurality of layers, wherein the glass panel defines a cavity between layers at an edge face of the glass panel; and
a fitting embedded within the cavity having a fitting face aligned with the glass panel edge face, wherein the fitting defines an elongated slotted inlay in the fitting face,
wherein the slotted inlay extends in the same direction as the layers at the edge face of the glass panel,
wherein the fitting does not extend through the glass panel.

15. An article of manufacture, comprising:
a glass panel defining a cavity extending from a plane face thereof; and
a fitting embedded within the cavity having an edge face aligned with the glass panel plane face, wherein the fitting defines an opening in the fitting face configured to receive a mechanical fastener,
wherein the fitting does not extend through the glass panel.

16. A method of fixing glass elements together, the method comprising:
embedding a fitting within a cavity of a first glass element, wherein the cavity does not extend through the first glass element;
coupling a fastener to the fitting in an opening of the fitting; and
coupling the fastener to a second element.

17. The method of claim 16, comprising:
embedding a second fitting within the second element, wherein the second element is formed of glass,
wherein coupling the fastener to the second element comprises coupling the fastener to the second fitting.

18. The method of claim 17, comprising:
embedding a third fitting within a third element, wherein the third element is formed of glass;
coupling a joint connector to the first fitting and the second fitting; and
coupling the joint connector to the third fitting.

19. The method of claim 18, wherein coupling the joint connector to the first fitting and the second fitting comprises:
positioning an attachment wing of the joint connector between a slotted inlay of the first fitting and a slotted inlay of the second fitting, wherein the slotted inlays are aligned;
rotating the attachment wing to position the attachment wing to extend within each of the aligned slotted inlays simultaneously.

20. The method of claim 19, wherein coupling the joint connector to the third fitting comprises extending a second fastener through the attachment wing between the first fitting and the second fitting and into the third fitting.
